(19) United States
(12) Patent Application Publication
(10) Pub. No.: US 2024/0367243 A1
(43) Pub. Date: Nov. 7, 2024

(54) Dry Wall Bead Press

(71) Applicant: Gerald Douillard, Sugar Hill, GA (US)

(72) Inventor: Gerald Douillard, Sugar Hill, GA (US)

(21) Appl. No.: 18/142,866

(22) Filed: May 3, 2023

(51) Int. Cl. B23D 29/00; B26B 5/00; B26B 29/06

(52) U.S. Cl. CPC B23D 29/005; B26B 5/005; B26B 29/06

(57) ABSTRACT

The subject matter relates to a drywall bead press that is able to cut drywall at various angles. The anvil anchors the device to the dry wall, allowing the handle to be rotated to the desired angle. Once the desired angle has been chosen, the upper handle mechanically forces the blade into the drywall.

### FIELD OF THE INVENTION

The present subject matter relates to a dry wall bead press that is capable of both straight and angled cuts.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include hardware components or modules that, for purposes of discussion, may be illustrated and described as if the majority of the components were implemented solely in hardware. It should be noted that a plurality of hardware devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The present subject matter comprises of a tool for cutting drywall beads that has a shaped cross section 5 that is capable of cutting to length with straight and angled cuts.

The device includes a base 10 with a first handle 15 attached to the base along with a second handle 20 pivotably attached to the base, wherein the cutting edge movably engages the base.

An anvil 30 pivotably attaches to the base and may be rotated to a chosen angle relative to the blade. The anvil has a shaped upper surface that engages the shaped cross-section of a drywall bead.

A mechanical linkage forces the cutting edge of the blade towards the anvil when the second handle is faced towards the first handle such that a drywall bead positioned over the anvil is cut at the desired angle.

### DESCRIPTION OF THE FIGURES

FIG. 1 shows a perspective view of the drywall bead press.

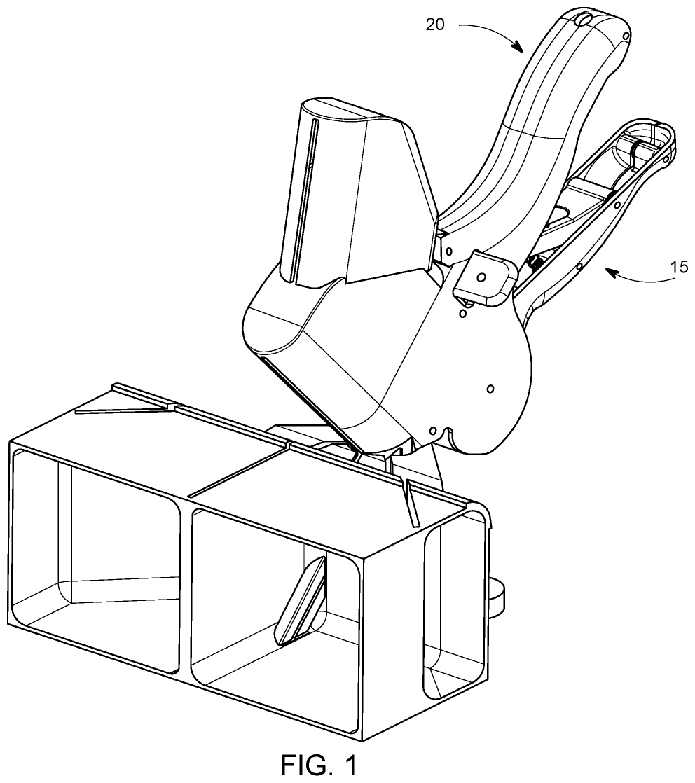

FIG. 2 shows a plan view of the drywall bead press.

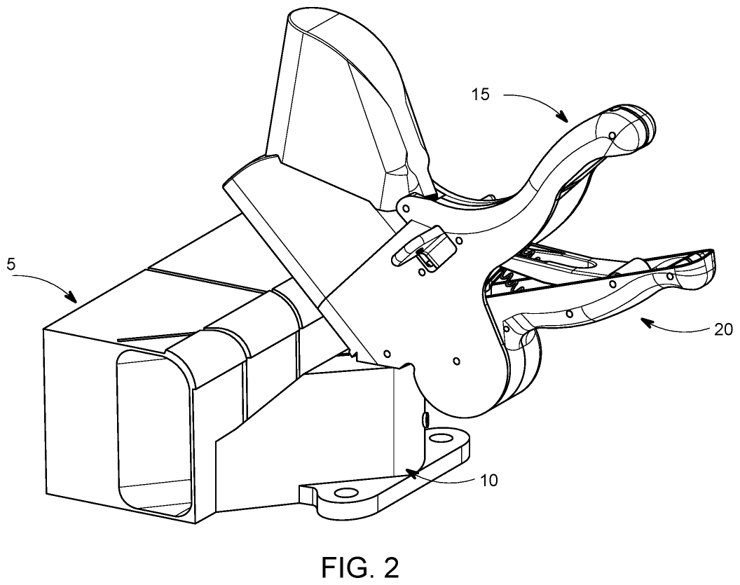

FIG. 3 shows a side view of the drywall bead press.

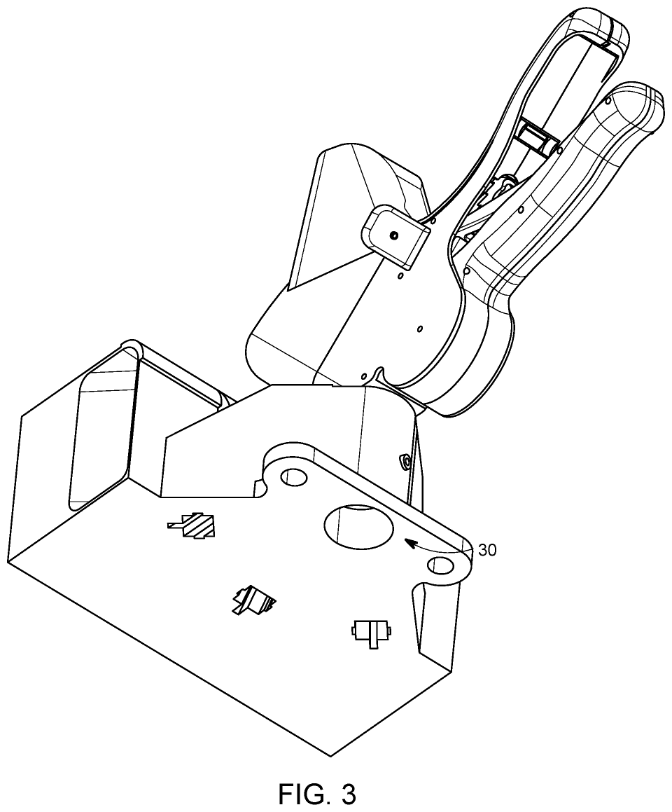

FIG. 4 shows an underneath view of the drywall bead press.

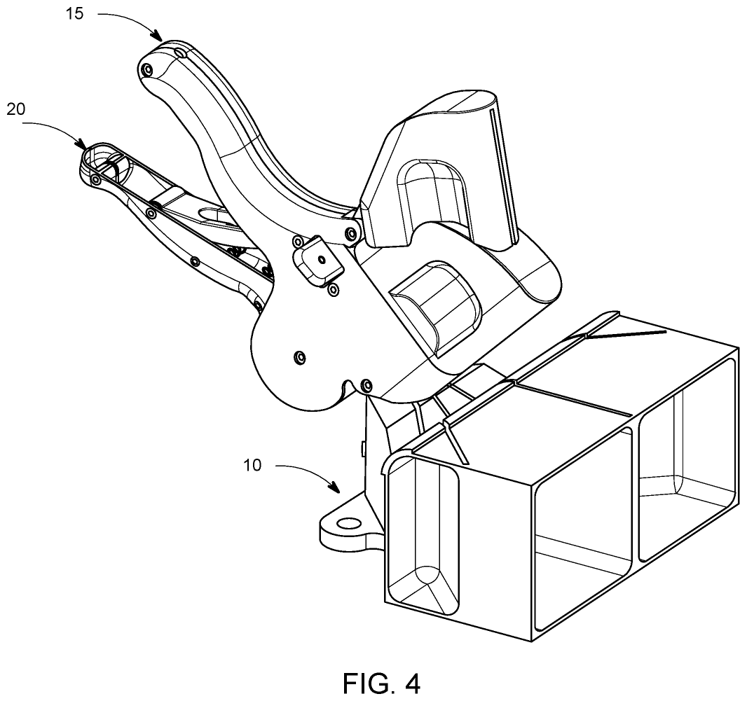

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

We claim:

1. A drywall bead press comprising of an upper and lower handle, an anchor, a shaped cross section, and a removable blade.

2. The drywall bead press comprising of an upper and lower handle, the anchor, the shaped cross section, and the removable blade as in claim 1, wherein the upper and lower handle are pivotably attached;

3. The drywall bead press comprising of an upper and lower handle, the anchor, the shaped cross section, and the removable blade as in claim 1, wherein the shaped cross section and anchor are affixed to each other;

4. The drywall bead press comprising of an upper and lower handle, the anchor, the shaped cross section, and the removable blade as in claim 1, wherein the upper and lower handles are pivotally connected to the shaped cross section;

5. The drywall bead press comprising of an upper and lower handle, the anchor, the shaped cross section, and the removable blade as in claim 1, wherein the shaped cross section has cutouts for straight and angled cuts; and

6. The drywall bead press comprising of an upper and lower handle, the anchor, the shaped cross section, and the removable blade as in claim 1, wherein the removable blade is mechanically forced through the shaped cross section to cut drywall at the desired angle.

7. A method of using a drywall bead press comprising of an upper and lower handle, an anchor, a shaped cross section, and a removable blade.

8. The method of using the drywall bead press comprising of the upper and lower handle, anchor, shaped cross section, and removable blade as in claim 7, wherein the upper and lower handle are pivotably attached.

9. The method of using the drywall bead press comprising of the upper and lower handle, anchor, shaped cross section, and removable blade as in claim 7, wherein the shaped cross section and anchor are affixed to each other;

10. The method of using the drywall bead press comprising of the upper and lower handle, anchor, shaped cross section, and removable blade as in claim 7, wherein the upper and lower handles are pivotally connected to the shaped cross section;

11. The method of using the drywall bead press comprising of the upper and lower handle, anchor, shaped cross section, and removable blade as in claim 7, wherein the shaped cross section has cutouts for straight and angled cuts;

12. The method of using the drywall bead press comprising of the upper and lower handle, anchor, shaped cross section, and removable blade as in claim 7, wherein the removable blade is mechanically forced through the shaped cross section to cut drywall at the desired angle.

13. A method of constructing a drywall bead press comprising of a upper and lower handle, anchor, shaped cross section, and a removable blade.

14. The method of constructing a drywall bead press comprising of the upper and lower handle, anchor, shaped cross section, and removable blade as in claim 13, wherein the upper and lower handle are pivotably attached;

15. A method of constructing a drywall bead press comprising of a upper and lower handle, anchor, shaped cross section, and a removable blade as in claim 13, wherein the shaped cross section and anchor are affixed to each other;

16. A method of constructing a drywall bead press comprising of a upper and lower handle, anchor, shaped cross section, and a removable blade as in claim 13, wherein the upper and lower handles are pivotally connected to the shaped cross section;

17. A method of constructing a drywall bead press comprising of a upper and lower handle, anchor, shaped cross section, and a removable blade as in claim 13, wherein the shaped cross section has cutouts for straight and angled cuts; and

18. A method of constructing a drywall bead press comprising of a upper and lower handle, anchor, shaped cross section, and a removable blade as in claim 13, wherein the removable blade is mechanically forced through the shaped cross section to cut drywall at the desired angle.
